(19) United States
(12) Patent Application Publication
(10) Pub. No.: US 2005/0204971 A1
(43) Pub. Date: Sep. 22, 2005

(54) Method and apparatus for improving the spacing between seeds planted by John Deere vacuum planter

(76) Inventor: Dale VenHuizen, Stockton, IL (US)

Correspondence Address: ROBERT L. MARSH, 54 DANADA DRIVE, P.O. BOX 4468, WHEATON, IL, 60187-4468, US

(21) Appl. No.: 10/803,265

(22) Filed: Mar. 18, 2004

(51) Int. Cl. A01C 5/00; A01C 7/00; A01C 9/00

(52) U.S. Cl. 111/185

(57) ABSTRACT

A seed planter of the type having a metering unit with a seed chute that drops seeds into a seed tube for planting is manufactured by John Deere. The upper end of the seed tube is moveable with respect to the seed chute, and movement of the upper end of the seed tube with respect to the seed chute causes seeds to ricochet down the seed tube and causes uneven spacing between seeds. A spacer between the seed chute and the seed tube reduces ricochet and causes the seeds to be planted with a constant spacing between seeds.

The present invention relates to seed planters of the type manufactured by John Deere which receive a rotatable seed disk and, in particular, to a method and apparatus for improving the spacing between seeds that are planted by such machines.

### BACKGROUND OF THE INVENTION

John Deere manufactures a Max Emerge Drawn Conservation Flex-fold planter. The heart of the John Deere planter is a metering unit which retains a circular rotatable seed disk that separates the interior of the metering unit into two chambers, one on each side of the disk. The seed disks employed in the machine have a plurality of holes, with the centers thereof spaced to define a circle having a radius a little less than the radius of the disk. A vacuum is drawn in the chamber formed on one side of the disk and seeds are introduced into the chamber on the opposite side of the disk. The diameter of the holes in the seed disks are sized such that, when operating properly, the vacuum will draw one seed against the aperture of each hole in the disk and retain the seed as the disk rotates to a position above a seed tube, at which point the disk moves away from the vacuum chamber and the seed falls away from the disk and into the seed tube to be planted.

The planter is intended for use with many types of seed, including sunflower, cotton, soybean, sorghum, sugar beets, popcorn, sweet corn, and corn seed (feed corn seed). Each type of seed has a different size and configuration and the planter is, therefore, provided with a plurality of seed disks, which each of the seed disks having a different configuration of holes through which the vacuum is drawn to move seeds from the input to the seed tube.

The manual for the 7200 Max Emerge, 16 row, narrow flex-fold planter, for example, describes and depicts thirteen different seed disks. According to the manual, the seed size for certain grains, such as corn seed, vary widely. The manual recommends disk H136478 for the smallest sized corn seed, recommends disk A43215 for medium sized corn seed, and recommends disk A50617 for large sized corn seed.

The proper operation of the John Deere planter, therefore, requires the selection of the appropriate seed disk for use with the size and type of seed to be planted, the appropriate adjustments to the vacuum drawn to one side of the seed disk and depending on the size of seed being planted, the installation or removal of certain optional features. It is also recommended that the machine be monitored during its use and that the strength of the vacuum be adjusted if the machine is found to be under planting or over planting seed.

The machine is considered to be operating at 100% efficiency if it will plant 100 seeds in 100 holes. Where the machine plants 98 seeds in one hundred holes, it is considered to be operating at 98% efficiency and where is planting 102 seeds in every 100 holes (a second seed into each of two holes), the machine is considered to be operating at 102% efficiency. A farmer will consider a machine operating outside the range of 95 percent to 105 percent to be unacceptably inefficient and in either case will be required to adjust the vacuum or replace the seed disks of the machine to improve its efficiency. The desired operating range for such machines is between 99 percent and 101 percent efficiency. The planters manufactured by John Deere are adapted to plant from four to thirty-one rows simultaneously with a metering unit including a hopper retaining seed and a seed disk for each row to be planted by the machine.

The difficulties of maintaining proper efficiency are accentuated in the case of corn seed, which is one of the major grains for which the John Deere planter is employed. Although it would be desirable for a farmer to obtain seed which is of all the same size, as a practical matter, he must deal with seeds of varying size. As previously stated, John Deere offers three different seed disks for use in planting corn seed, one disk for each of three ranges of seed size.

John Deere has many thousands of Max Emerge planters, many of which are now being employed to plant corn seed. Farmers have found that, with respect to the planting of corn seed, the John Deere planter can best be described as temperamental.

In my patent application filed Mar. 28, 2002 and assigned Ser. No. 10/109,194, I disclosed a kit that includes an improved seed disk for insertion into the metering unit of a John Deere planter to improve the efficiency with which seed, especially corn seed, is planted. Seeds released into the seed tube from the improved seed disk, however, are released near a side of the seed tube that has a sloping wall. The seed tube as currently made by John Deere does not fit snugly against the seed discharge of the metering unit such that the upper end of the seed tube can move back and forth with respect to the metering unit as the planter moves across uneven ground. As a result, some seeds that are dropped from the metering unit into the seed tube strike the sloping wall of the seed tube as they fall and others do not. The seeds that strike the sloping wall ricochet down the tube and therefore take longer to fall through the tube than those that do not strike the sloping wall, and therefore, the spacing between the seeds of a row planted by the machine having a seed disk according to my prior patent application are uneven. Some seeds are therefore planted too near to another seed such that the yield from the field is reduced. It would be desirable, therefore, to provide a method and apparatus to reduce or prevent seeds dropped from the metering unit from striking the sloping walls of the seed tube.

### SUMMARY OF THE INVENTION

Briefly, the present invention is embodied in a method and apparatus for improving the spacing of seeds planted by a seed planter of the type manufactured by John Deere, having a metering unit for retaining a circular rotatable seed disk wherein seed is introduced into a first cavity in the metering unit defined by a first surface of the seed disk and a vacuum in drawn in a second cavity defined by the second surface of the seed disk. The vacuum draws individual seeds against transverse holes in the seed disk and release the seeds to drop through a seed chute in the bottom of the metering unit and into the upper end of a seed tube that directs the seed into the ground for planting.

The seed chute is a channel having a generally rectangular opening with two long sides generally parallel to the seed disk and two short sides perpendicular to the long sides. The seed tube is an elongate tubular member having a generally rectangular cross-section which flares outward at the upper end thereof. The upper end of the seed tube is rectangular in shape with long sides that are a little longer than the outer dimensions of the long sides of the seed chute and short sides that are a little longer than the short sides of the seed chute.

The short sides of the upper end of the seed tube, as manufactured by John Deere, however, are approximately three-eighths inch to one-half inch wider than the outer dimensions of the short sides of the seed chute, such that the seed tube is laterally moveable back and forth with respect to the metering unit during operation of the planter. The flared shape at the upper end of the seed tube causes the inner surface of the seed tube directly below the seed chute to be inclined. As a result of the lateral movement of the seed tube with respect to the seed chute, an incline surface within the seed tube is allowed to move toward and away from the stream of dropping seeds emitted from the seed chute. When the seed tube is moved in one direction with respect to the metering unit, a seed dropped from the seed chute will not strike the incline surface of the seed tube, but when the seed tube is moved in the opposite direction, a seed dropped from the seed chute will strike the inclined surfaces. I have found that a seed that strikes the incline surface of the seed tube will ricochet back and forth against the walls of the seed tube as it drops down the tube, thereby slowing the speed at which it drops. If the immediately preceding seed did not strike the inclined surface, the spacings between the seeds will be inordinately large. On the other hand, if the seed following the seed that ricochets down the seed tube does not strike the incline surface, the following seed will move much more rapidly through the seed tube and it will be spaced much closer to the ricocheting seed. The consequence of the movement of the seed tube with respect to the seed chute is the uneven spacing of the seeds as they are planted.

In accordance with the invention, a spacer is placed between the inner surface of one of the long sides of the seed tube and the complementary outer surface of the seed chute such that the incline surface of the seed chute is maintained as far as possible from the stream of dropping seeds, thereby eliminating, or greatly reducing, the incidence of ricochet of a seed dropping through the seed tube.

The invention, therefore, is the provision of a spacer between a surface of the seed chute and a complementary surface of the seed tube to prevent the lateral movement of one with respect to the other.

### BRIEF DESCRIPTION OF THE DRAWINGS

A better and more complete understanding of the invention will be had after a reading of the following detailed description taken in conjunction with the drawings wherein:

FIG. 1 is a an isometric view of a John Deere planter;

FIG. 2 is a rear elevational view of the John Deere planter shown in FIG. 1;

FIG. 3 is a side elevational view of a row unit of the planter shown in FIG. 1 with the metering unit therein shown in broken lines;

FIG. 3A is an enlarged fragmentary side elevational view of the row unit shown in FIG. 3 with the metering unit visible within;

FIG. 4 is an isometric view of a metering unit for the row unit shown in FIG. 3;

FIG. 5 is an isometric view of the metering unit as shown in FIG. 4 with the housing opened to show the interior thereof;

FIG. 6 is a second isometric view of the metering unit as shown in FIG. 4 with the feed wheel installed cross-sectional view of the metering unit shown in FIG. 4;

FIG. 7 is a front elevational view of the first housing member of the metering unit shown in FIG. 4 with the seed disk partially broken away;

FIG. 8 is a cross-sectional view of the metering unit shown in FIG. 4;

FIG. 9 is a rear elevational view of a seed disk for use in the metering unit shown in FIG. 4;

FIG. 10 is a front elevational view of the seed disk shown in FIG. 9; sizes of feed corn seed; and

FIG. 11 is a fragmentary side elevational view of the metering unit showing the seed tube attached to the lower end of the seed chute, with the seed tube partially broken away to show a spacer in accordance with the invention;

FIG. 12 is a fragmentary rear view of the metering unit and seed tube shown in FIG. 11;

FIG. 13 is a fragmentary isometric view of the seed chute of the metering unit showing the cover removed from the seed chute;

FIG. 14 is a fragmentary isometric view of the seed chute shown in FIG. 13 with the cover assembled thereto and the upper end of the seed tube ready for assembly to the seed chute;

FIG. 15 is a front elevational view of the spacer attached to the cover visible in FIG. 14;

FIG. 16 is a cross-sectional view of the spacer shown in FIG. 15 taken through line 16-16 thereof;

FIG. 17 is a fragmentary cross-sectional view of the metering unit and seed chute having the spacer shown in FIG. 15 therein, the cross-section taken through line 17-17 of FIG. 11; and

FIG. 18 is a fragmentary cross-sectional view of the metering unit and seed chute similar to that shown in FIG. 17, but not having a spacer in accordance with the present invention.

### DETAILED DESCRIPTION OF A PREFERRED EMBODIMENT

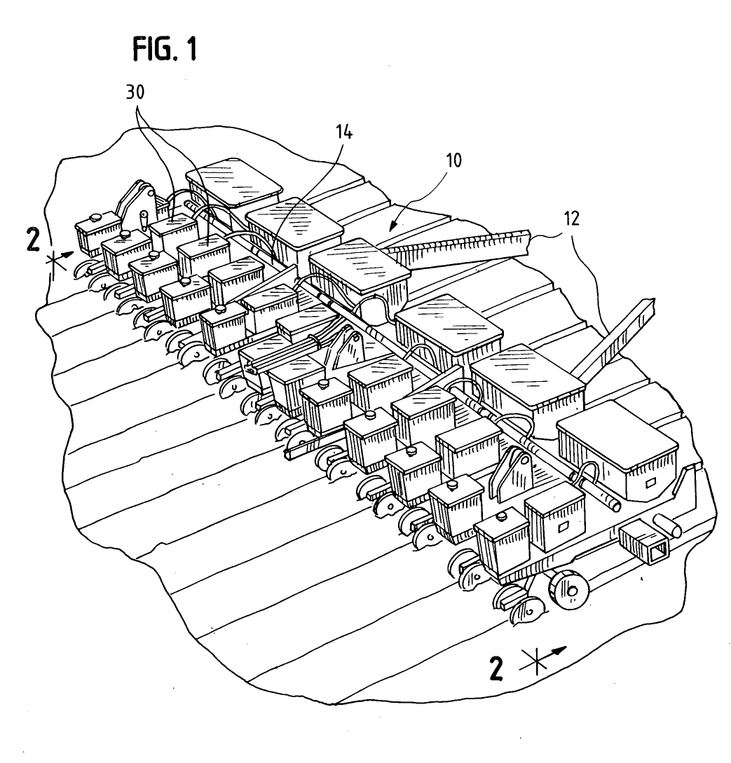

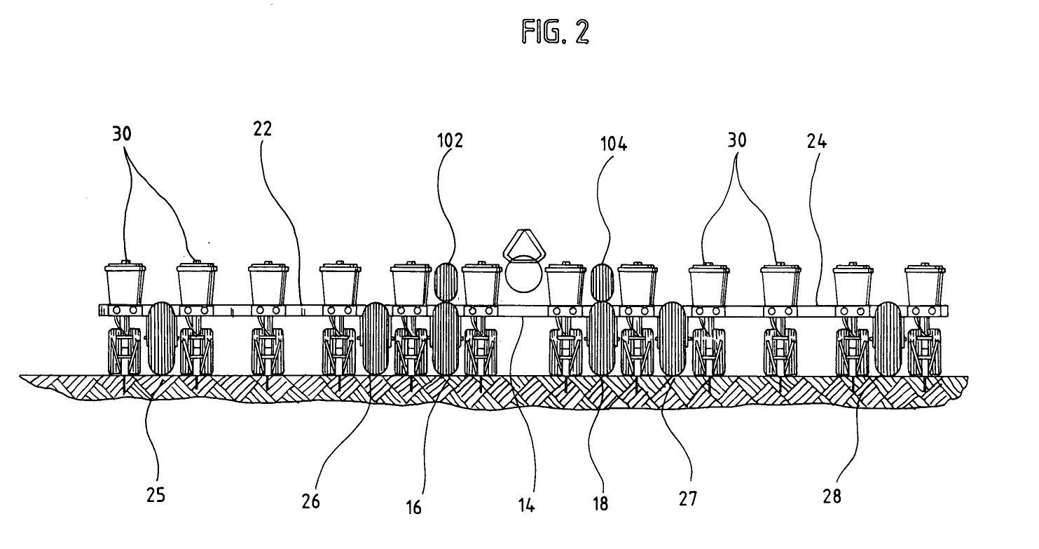

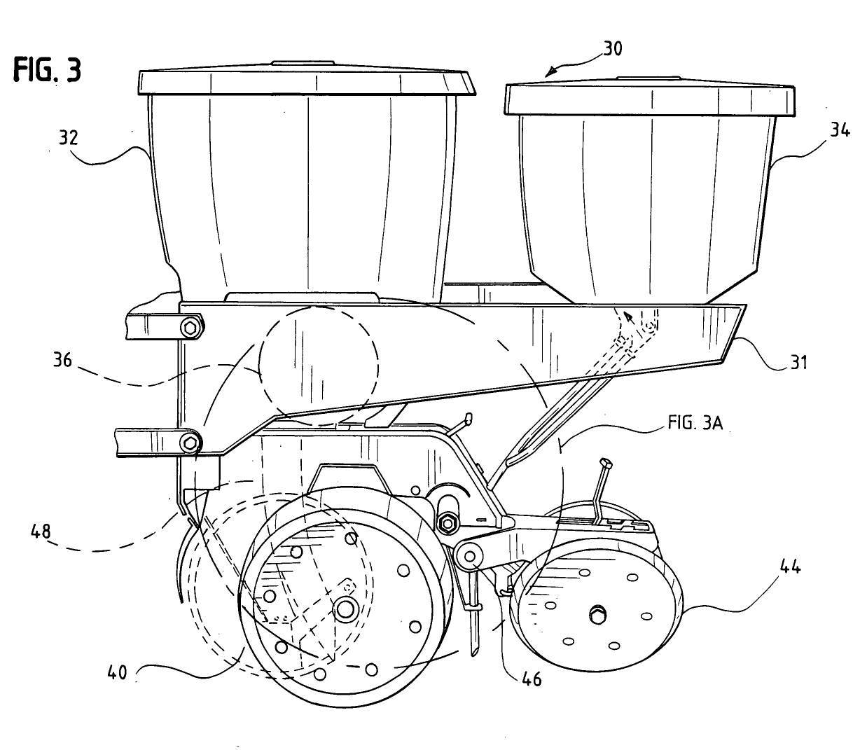

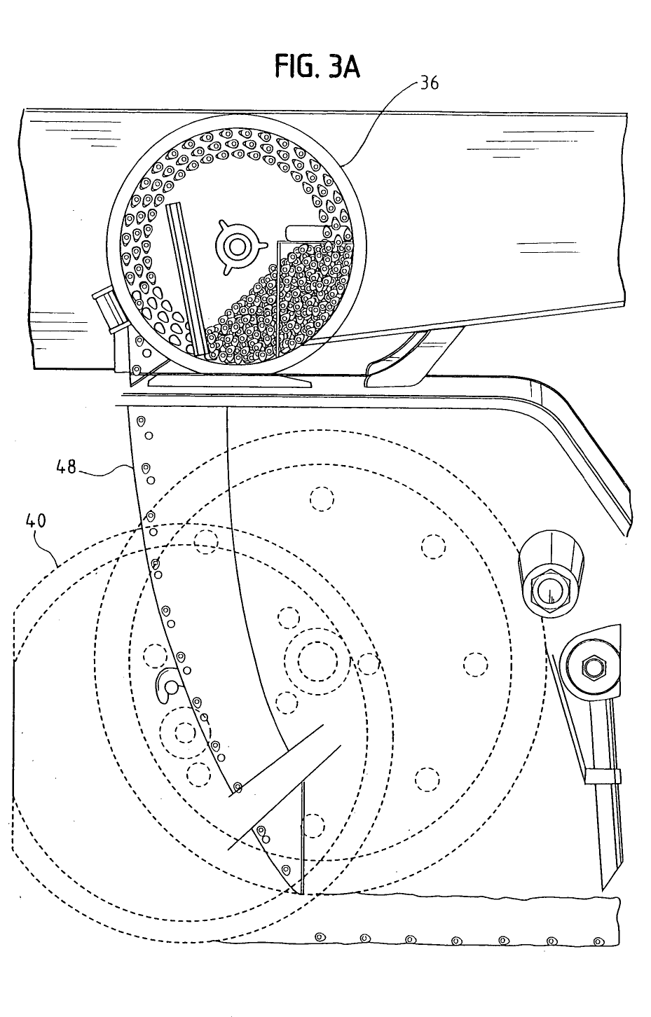

Referring to FIGS. 1 and 2, a John Deere planter such as a 7200 Max Emerge Flex-fold planter 10 includes a pair of elongate tow bars 12 at the rearward end of which is a cross bar 14 having wheels 16, 18 for transporting the planter 10 across the open highway. Attached by pivots, not visible, to the cross bar 14 are end sections 22, 24 having wheels 25, 26 and 27, 28 respectively. The pivots permit movement of the end sections 22, 24 from a first position in which they are folded against the tow bars 12 for transporting across an open highway, to a second position, depicted in FIGS. 2 and 3, in which they extend linearly outward from the ends of the cross bar 14. Extending along the length of the cross bar 14 and the extension sections 22, 24 are a plurality of row units 30-30. John Deere manufactures planters 10 which vary in width from four to thirty one row units.

The model 7200 planter was first offered in 1987 and since then John Deere has placed several other models on the market including models 1750, 1760, 1770, and 1780, each of which has corresponding parts and the performances of all of which are improved by the use of the present invention.

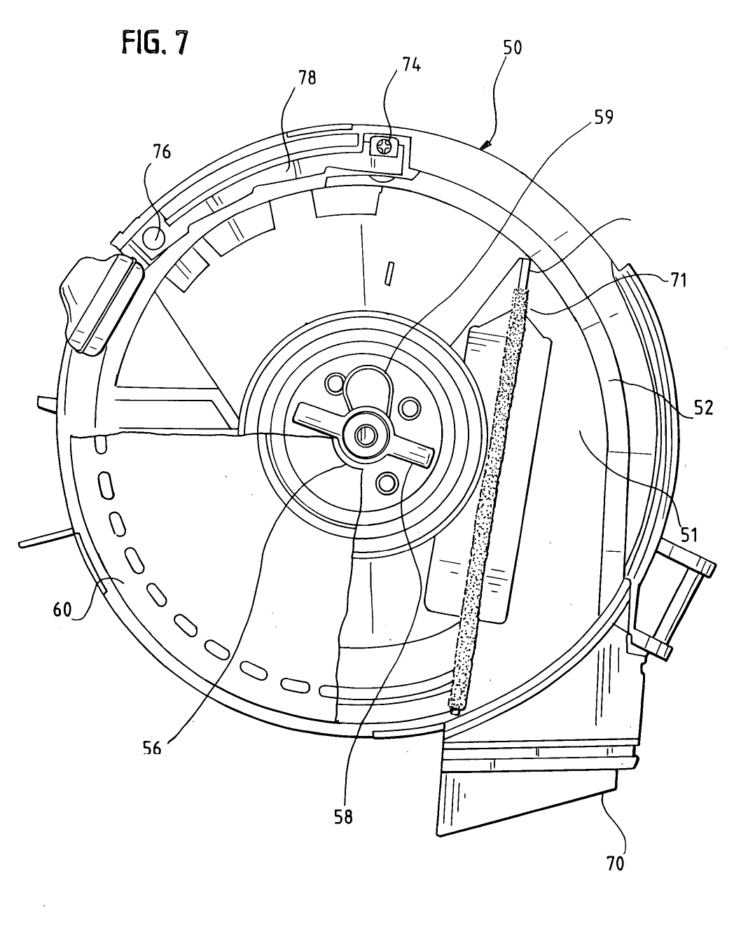

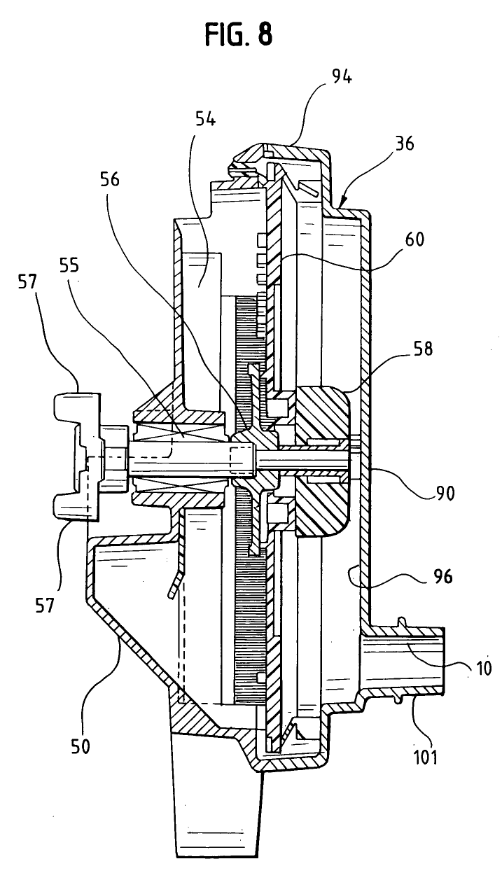

Referring to FIGS. 3, 3A and 8, each row unit 30 has a frame 31 on which is mounted a first hopper 32 for retaining seed and a second hopper 34 for retaining a dry herbicide. Below the seed hopper 32 is a metering unit 36 and a chute, not shown, directs seed from the hopper 32 to the metering unit 36. Below the metering unit 36 are opener discs 40. Rearward of the opener discs 40 are closing wheels 44, the elevation of which is adjustable through a pivot 46 to thereby permit the opener discs 44 to create a trench of the depth desired for the seed being planted.

A seed tube 48 extends from the metering unit 36 to a position between the opener discs 40 for directing individual seeds singulated by the metering unit 36 into the furrow of ground formed by the opener discs 40, thereby planting the seed. A gearing assembly, not shown, connected to the wheels 16, 18, 25-28 rotates a drive member, not show, which engages a winged connector 57 on the inner shaft 55 of the metering unit 36 such that the rate at which the metering unit discharges seed is coordinated to the ground speed of the planter 10.

When the planer 10 operates properly, the planted seed will have a predetermined spacing, such as six inches, between adjacent seeds. If the spacing between adjacent seeds is too close, the plants that grow from the seed will interfere with each other and thereby reduce the yield of the field. If the spacing between seeds is too far apart, the yield from the field will also be reduced and therefore, yield is maximized when the seed is consistently planted with the desired spacing between seed.

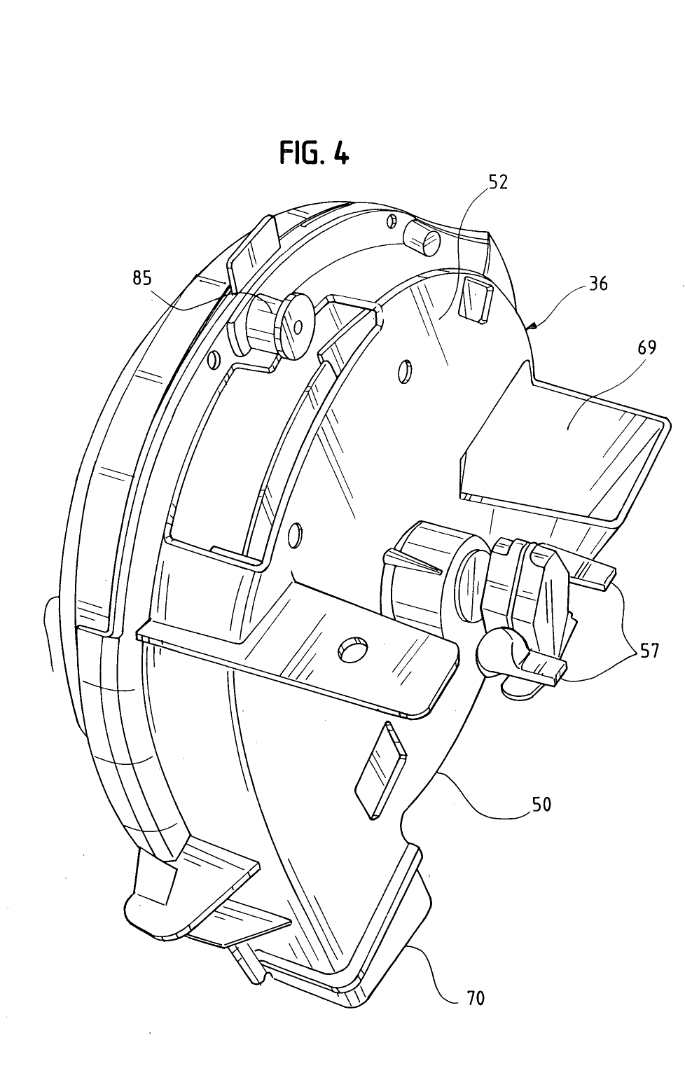

Referring to FIGS. 4,5, 6, 7 and 8, the metering unit 36 includes a first housing member 50, having a generally cylindrical outer wall 52 and a planar rear wall 54 thereby forming a cavity. Extending from the rear wall 54, axially with respect to the cylindrical outer wall 52, is a tubular retaining hub 56 at the distal end of which is a winged hub handle 58 which is rotatable between a first position for receiving or removing a seed disk 60 and a second position for retaining a seed disk 60 on the hub 56.

Referring to FIGS. 5 and 8, the retaining hub 56 is threaded on a cylindrical drive shaft 55 at the distal end of which are a pair of flanges 57 for drivingly engaging a drive member, not shown, which in turn is drivingly connected by the gearing, also not shown, to the wheels 16, 18, 25-28. A removable spring locking pin 59 extends through holes, not shown, in the tubular retaining hub 56 and through the inner drive shaft 55. By removing the spring locking pin 59, the retaining hub 56 can be rotated with respect to the inner shaft to thereby axially move the retaining hub 56 with respect to the rear wall 54 of the first housing member 50. Rotating the retaining hub 56 clockwise with respect to the drive shaft moves a seed disk 60 retained thereon toward the rear wall 54 and rotating the retaining hub 56 counter clockwise moves a seed disk 60 thereon away from the rear wall 54 of the first housing member 50.

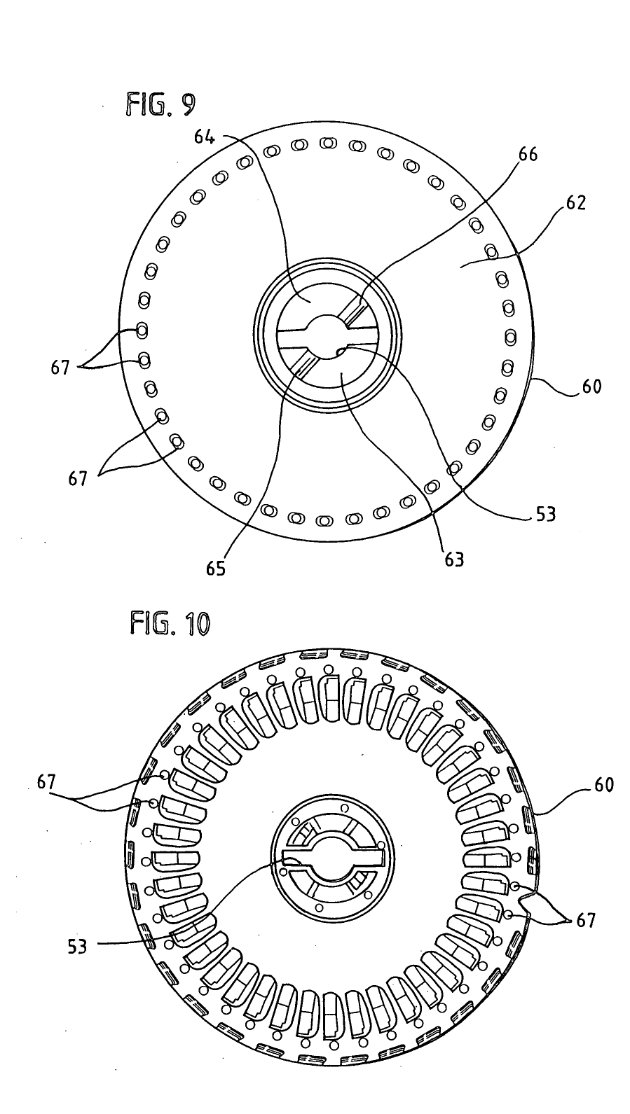

Referring briefly to FIGS. 9 and 10, the seed disk 60 has a generally circular body with first and second planar surfaces 61, 62, and having a wing shaped central opening 53. The opening 53 is shaped to receive the winged hub handle 58 at the distal end of the retaining hub 56 of first housing member 50. Surrounding the central opening 53 on the second side 62 are two arcuately shaped opposing ramped surfaces 63, 64 and opposing locking notches 65,66 for locking the seed disk 60 to the hub 56. Extending around a circle which is spaced a short distance within the outer circumference of the seed disk 60 are a plurality of spaced transverse holes 67-67. The diameter of the cylindrical outer end of the seed disc 60 is a little less than the inner diameter of the tubular outer wall 52 of the first housing member 50 of the metering unit 36 (and of the cylindrical outer wall of the second housing member 90, as is further described below).

Referring further to FIG. 4, the first housing 50 includes an upwardly opening access port 69 in the rear wall 52 into which the lower end of the chute from the hopper 32 extends, allowing seeds to enter the first housing member 50. Approximately diametrically opposite the access port 69 is a seed chute 70 in the cylindrical wall 52 of the housing member 50 through which singulated seeds drop and fall into the seed tube 48 for planting. When assembled on a row unit 30, the metering unit 36 is oriented with the axis of the hub 56 horizontal and the seed chute 70 extending downward as is shown in FIG. 4.

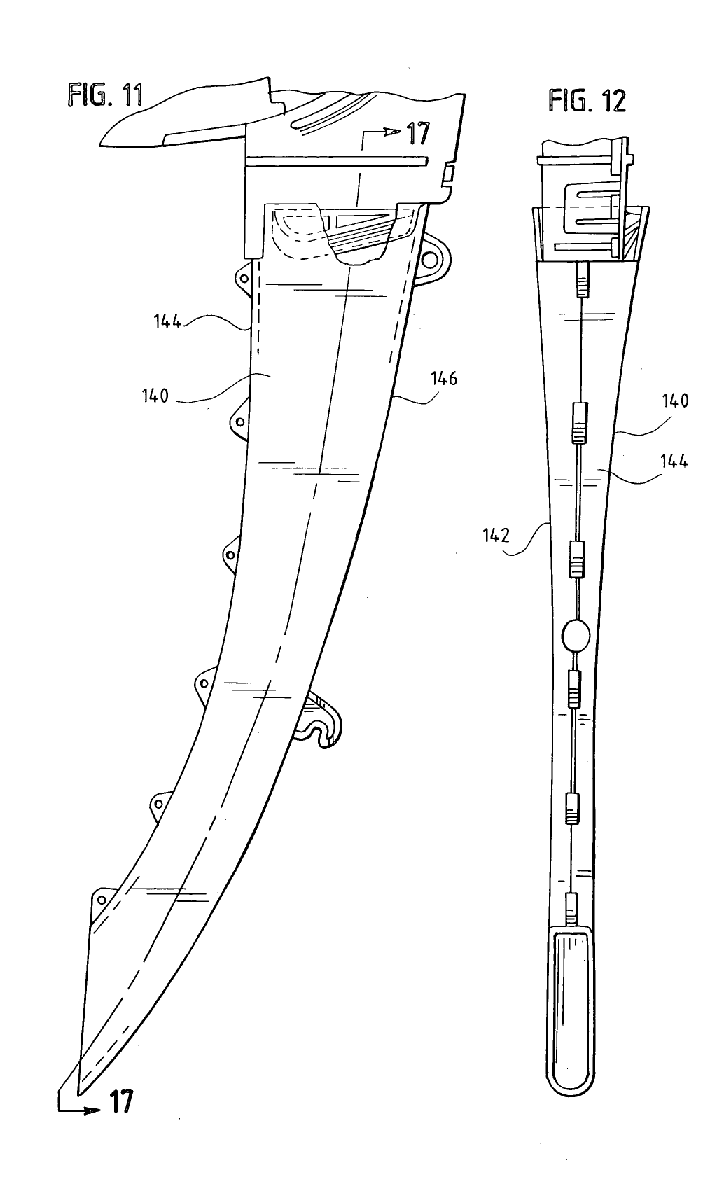

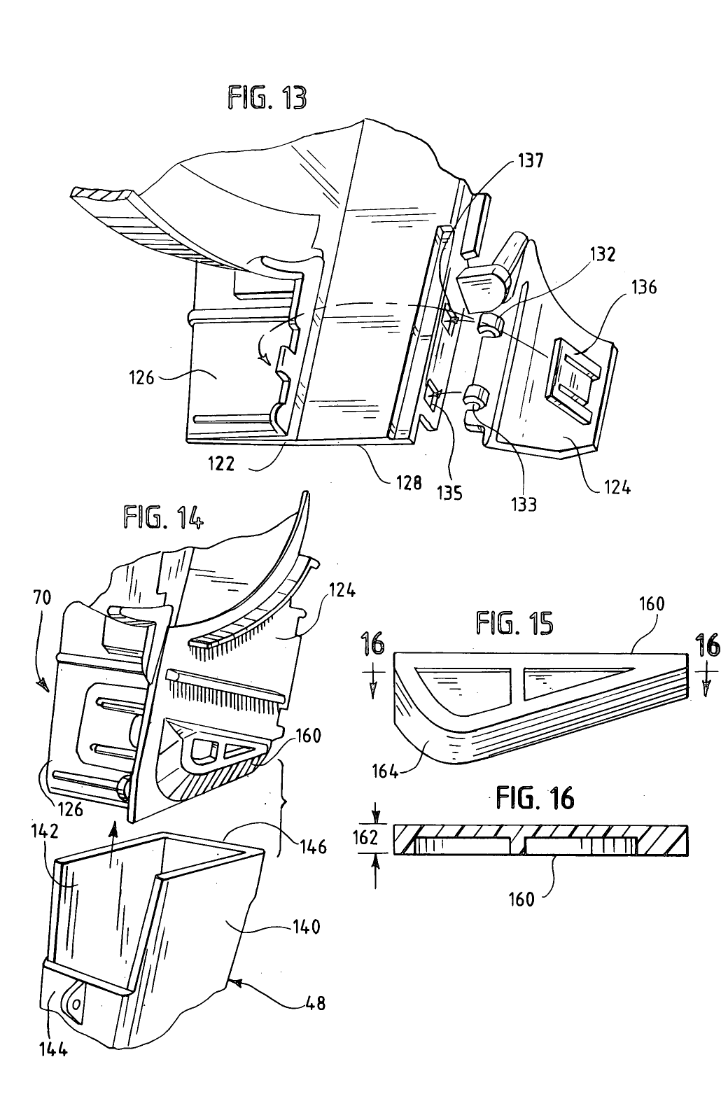

Referring to FIGS. 13 and 14, the seed chute 70 is a short, tubular member with a generally rectangular cross-section having parallel long sides 122, 124 and parallel short sides 126, 128. The short sides 126, 128 and long side 122 are formed as part of the casting for first housing member 50 and create a channel. Long side 124, extends generally parallel to long side 122 and is formed by a plastic member 129 that extends across the ends of short sides 126, 128 and is held in place by hooks 132, 133 that are received in holes 134, 135 in the ends of short side 128 and by a removable snap 136 that attaches to short side 126.

Referring to FIGS. 11, 12 and 18, the seed tube 48 is an elongate, tapered, tubular member having a rectangular cross-section consisting of first and second opposing side members 140, 142 and generally perpendicular thereto, third and fourth side members 144, 146. The seed tube 48 is molded of plastic and has formed into the body thereof a pair of opposingly extending pivot pins 148, 150 at the upper end thereof and midway along the length, a downwardly extending hook 152 for attachment of the seed tube 48 to the row unit 30.

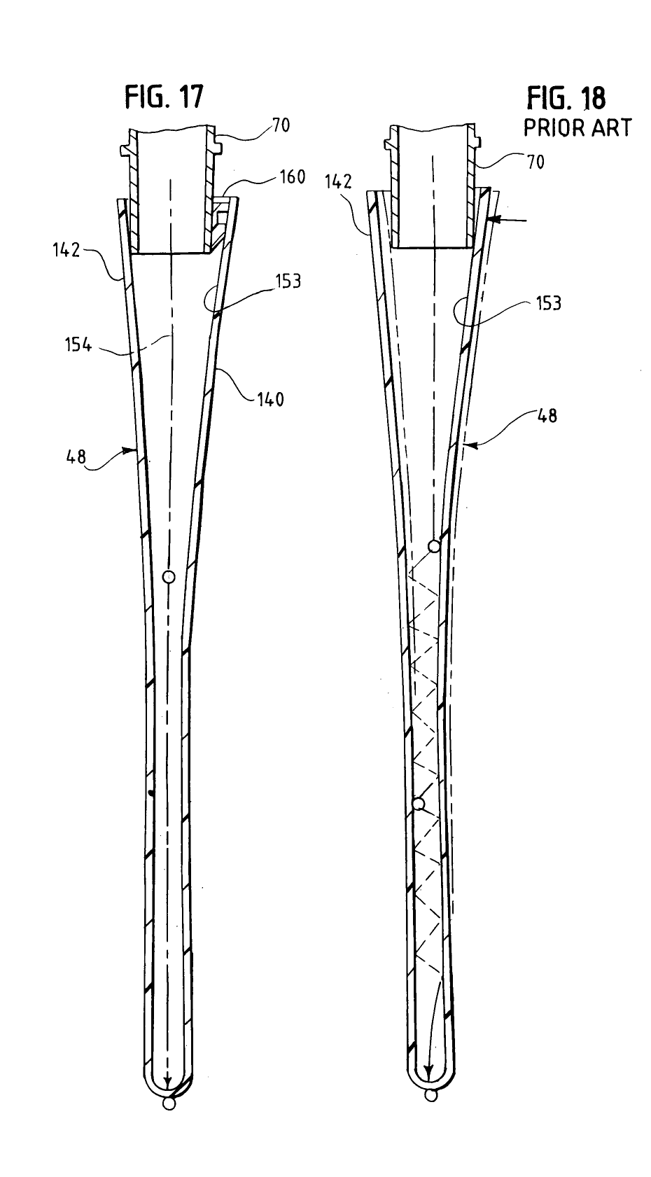

As best shown in FIG. 17, the wider side members, 140, 142 are generally parallel to each other through the lower two-thirds of the length thereof and flare outward from each other at the upper end with the flare becoming more drastic at the uppermost end. The flared walls of the side members 140, 142 causes the inner surface 153 of side 140 to be sloped or angled with respect to the centerline 154 of falling seed dropping from the seed chute 70 as is further described below. The inner dimensions of the side members 140, 142, 144, 146 are a little larger that the complementary outer dimensions of walls 122, 124, 126, 128 of the chute 70 such that the upper end of the seed tube 48 will receive the seed chute 70.

The inner dimensions of the short side members, 148, 146 of the seed tube 48 are perhaps three-eighths to a half inch larger than the outer dimensions of the short sides 126, 128 of the seed chute 70 such that when the parts are assembled to a row unit 30, the upper ends of side member 140 is moveable toward and away from the complementary long side member 122 of the seed chute 70 during operation of the planter 10.

Referring to FIG. 5, extending across the rear surface of the first housing member 50 and adjacent the hub 56 is an elongate brush 71 having one end connected to the outer wall 52 and the second end spaced a short distance from the cylindrical outer wall 52 leaving a gap 65 between the distal end of the brush 71 and the inner surface of the cylindrical outer wall 52. The brush 71 is positioned to separate seed entering the access port 69 from inadvertently reaching the seed chute 70. The bristles of the brush 71 extending axially away from the rear wall 52 and brush against the first surface 61 of a seed disk 60 which has been retained the retaining hub 56 thereby creating a partial barrier between the outer wall 52 and the seed disk 60. The brush 71 insures that seeds singulated by the seed disk 60 are removed therefrom as the disk passes over the seed chute 70 in the wall 52 and further to separate the loose seeds entering through the port 69 from inadvertently entering the seed chute 70 and falling into the seed tube 48.

Referring further to FIGS. 4, 5, 6 and 8, the metering unit 36 includes a second housing member 90 attached by a pivot pin 92 to the first housing member 50. The second housing member 90 has a generally tubular outer wall 94 and a planar rear surface 96 such that it too has a cavity therein. The tubular outer wall 96 includes an intrusions portion 98 and around the inner edge of the outer wall 94 and the intrusion portion 98 is a rubberized sealing member 99 which seals against the second surface 62 of a seed disk 60 when the housing members 50, 90 are assembled against each other as further described below.

The second housing member 90 further has an aperture 100 in the rear wall 96 and the outer surface of the second housing member has a tubular protrusion 101 the inner opening of which communicates with the aperture 100 and is adapted to receive a vacuum hose, not shown, leading from a vacuum pump. Most John Deere planters 10 have one or two vacuum pumps 102, 104 (visible in FIG. 2 only).

Referring to FIGS. 5, 6 and 13, within the intrusion portion 98 of the second housing member 90 is a third cavity defined by a portion of the cylindrical outer wall 94 and the wall of the intrusion portion 98, and a portion 110 of the rear surface 96. The pair of threaded holes, not shown, in the rear surface 110 is adapted to receive a knockout assembly 120 of the type manufactured by John Deere.

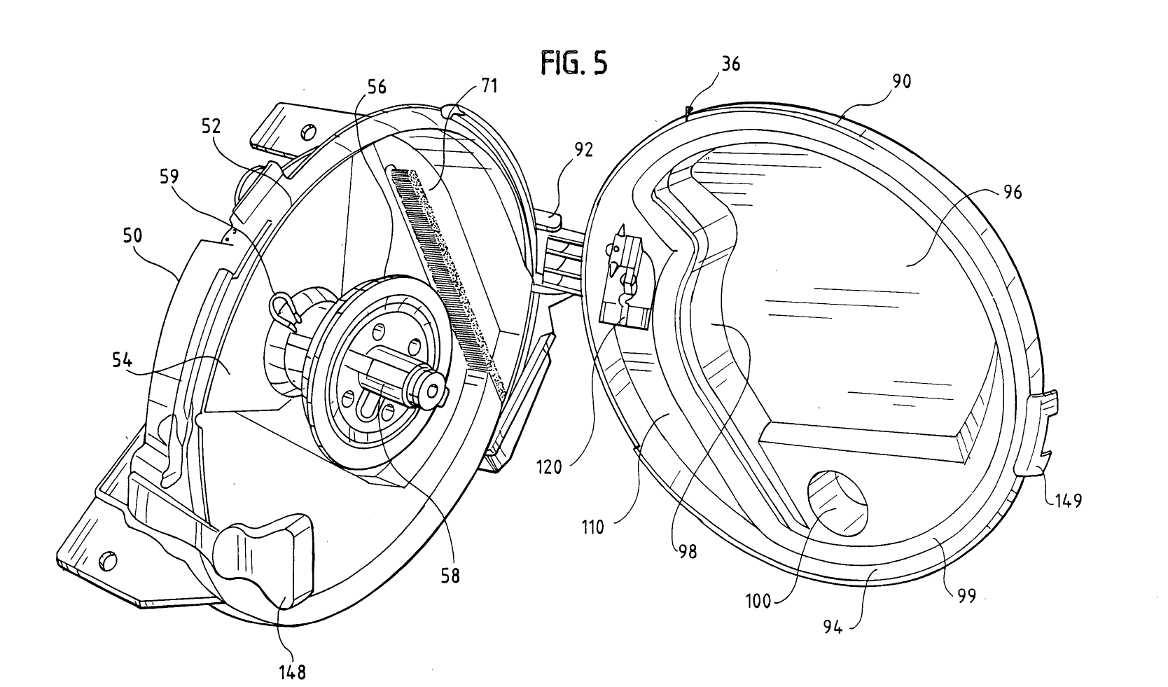

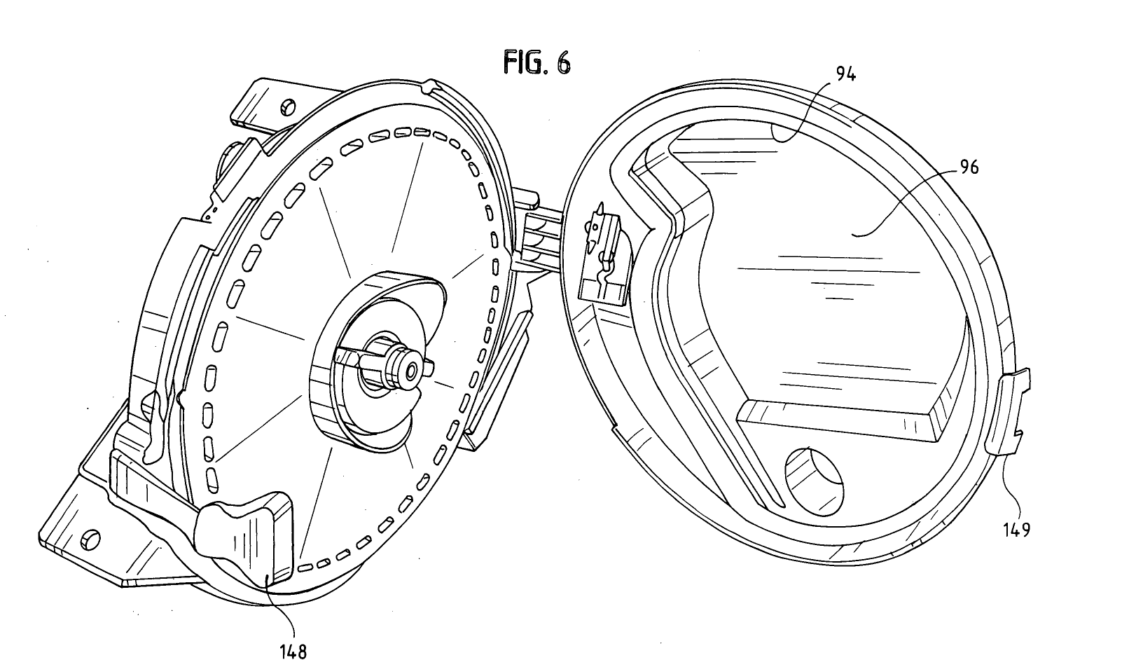

Referring to FIG. 6, a latch assembly 148 on the first housing member 50 is adapted to engage a second latch member 149 on the second housing member 90 for retaining the two housing members 50, 90 engaged with one another, to thereby form the assembled metering unit 36.

As shown in FIG. 8, when the two housing members 50, 90 are latched in assembled relationship, with a seed disk 60 retained on the retaining hub 56 of the housing member 50, the interior of the metering unit 36 will be divided into two chambers. The first chamber is defined by the cavity in the first housing member 50 and the first surface 61 of the seed disk 60. The second chamber is defined by the cavity in the second housing member 90 and the second surface 62 of the seed disk 60. It should be appreciated that the second chamber excludes the intrusion portion 99 of the second housing member 90.

A vacuum is drawn by the vacuum pumps 102, 104 through lines connected to the second housing member 90 and through the aperture 100 creating a vacuum in the second chamber of the metering unit 36. Meanwhile, seeds from within the seed hopper 32 drops through the chute 38 and through the port 69 into the first chamber. When the metering unit 36 is operating properly, the vacuum in the second chamber is drawn through the plurality of holes 67-67 of the seed disk 60 except for those holes 67-67 positioned beyond the sealing member 99 (defined by the intrusion portion 98). As the disk 60 rotates through the mass of seeds which accumulate near the port 69, one seed is drawn by the vacuum against each of the transverse holes 67-67. As the seed disk 60 continues to rotate within the metering unit 36, the singulated seeds are moved through the gap 65 at the distal end of the brush 71 and over the seed chute 70 in the outer wall 52 of the second housing member 50. As each of the singulated seeds is moved over the seed chute 70, the aperture of the associated hole 67 on the second side 62 of the seed disk 60 crosses the vacuum barrier formed by the sealing member 99, thereby releasing the seed from the first side 61. The seeds are thereby allowed to drop through the seed chute 70 in the outer wall 52 of the first housing member 50 and through the seed tube 48 to be planted.

If, during the course of using the planter 10, it is found that the planter 10 is under planting seeds or over planting seeds (operating at less than 95 percent efficiency or over 105 percent efficiency), the operator must stop his tractor and make adjustments to the vacuum drawn by the pumps 102, 104. Also, if the operator exhausts his supply of a given size of seed and is required to significantly change seed size, he must unlatch all of the latch assemblies 148, 149 of the metering units 36 and replace the seed disks 60 therein with another disk having the configuration of holes 69-69 suitable for the size of seed which he is now using. The instructions from John Deere may further require the installation and adjusting or removal of a double eliminator 78, and/or the installation or removal of a knockout assembly 120. Where a knockout assembly 120 is already in use, replacing a seed disk 60 may require the replacement of the knockout assembly 120 because the arm 124 must be configured differently for each of the seed disks 60. Similarly, the changing of a seed disk 60 may require the adding, removal, or adjustment of a double eliminator 78.

In my co-pending patent application, Ser. No. 10/109,194 filed Mar. 28, 2002, I disclosed a kit including a seed disk 60 for modifying the metering unit 36 of each row unit 30 so that the metering unit 36 will consistently plant a wide range of sizes and shapes of seed and thereby improve the efficiency at which the planter 10 pants seed.

The seed disks 60 sold by John Deere for planting corn in the planer 10 have contoured pockets, not shown, with raised outer boundaries that surround the openings for the vacuum holes 67 on the first side 61 thereof. The pockets and raised boundaries are intended to assist in singulating the seed. The seed disk 60 disclosed in my co-pending application has a flat first surface 61 against which the seeds are held as they are moved over the seed chute 70. The absence of raised boundaries around the vacuum holes 67 causes seed dropped from the seed disk 60 disclosed in my co-pending application to drop through the seed chute 70 nearer to the second housing 90 than do seeds dropped by the disks 60 sold by John Deere for planting corn seed.

Referring to FIGS. 17 and 18, the lateral movement of the upper end of the seed tube 48 with respect to the seed chute 70 causes the sloping inner surface 153 to move toward and away from the centerline 154 of seeds falling from the seed chute 70. When the side member 140 is moved towards the centerline 154 of falling seeds, the sloping inner surface 153 of side member 140 will be struck by seeds falling through the seed chute 70. This is particularly true where the metering unit 36 is fitted with a seed disk 60 in accordance with my previously filed co-pending application having a flat surface against which the seeds are retained. Seeds that fall through seed chute 70 and strike the sloping surface 153 will ricochet down the length of the seed tube 48 before reaching the lower end thereof, whereas seeds that do not strike the sloping surface 153 will generally fall directly through the length of the seed tube 48 to the lower end thereof for planting. Where a first seed falls through the seed tube 48 without ricocheting off the sloping surface 153 is followed by a second seed that ricochets off the surface 153, the second seed will fall much slower than the first seed and sit will be spaced further apart than is normally desired. Where a third seed follows the second seed and does not strike the sloping surface 153, the third seed will fall much more rapidly than the second seed and the spacing between the second and third seed will be much closer than desired. As a consequence, the plants that grow from the second and third seeds will interfere with each other, causing a reduction in the productivity of the field.

To reduce, or prevent altogether, the ricochet of seeds off the sloping surface 153, a spacer 160 in accordance with the present invention is fitted between the inner surface 153 of wide side member 140 of the seed tube 48 and the outer surface of long side 122 of seed chute 70. The spacer 160 has a thickness 162 that is sufficient to prevent the lateral movement of the upper end of the seed tube 48 with respect to the seed chute 70. For seed tubes and metering units currently manufactured by John Deere, the spacer 160 should have a thickness 162 of about one-fourth inch.

The spacer 160 can be attached by an adhesive to either the outer surface of the plastic member forming long side 122 of the seed chute 70 or to the inner surface wide side member 140 of the seed tube 48. In the embodiment depicted, the spacer 160 is bonded by an adhesive to the outer surface of the plastic member 122. As a third embodiment, the spacer 160 can be incorporated into the plastic member 129 with the plastic member 129 and the spacer 160 molded as a single part as shown in FIG. 14.

To facilitate the attachment of the seed tube 48 to the lower end of the seed chute 70, the spacer 160 preferably has a tapered edge 164 as shown.

When the seed tube 48 is attached to a seed chute 70 with a spacer 160 fitted between the parts thereof, the sloping inner surface 153 will be urged away from the center line 154 of falling seeds and few seeds, if any, falling through the seed chute 70 will strike the sloping surface 153, thereby reducing or eliminating the instances of ricochet. Accordingly, the row unit 30 will plant seeds which are consistently spaced.

While the present invention has been described with respect to a single embodiment, it will be appreciated that many modifications and variations may be made without departing from the true spirit and scope of the invention. It is, therefore, the intent of the appended claims to cover all such modifications and variations which fall within the true spirit and scope of the invention.

1. In a seed planter of the type having a metering unit for retaining a circular rotatable seed disk, said seed disk having a center, a first surface, a second opposing surface, and a plurality of transverse spaced vacuum holes through said seed disk, wherein seeds are introduced into a first cavity in a housing defined by said first surface and a vacuum is drawn into a second cavity in said metering unit defined by said second surface, such that seeds are retained against said vacuum holes until they are dropped through a seed chute and into a seed tube, and wherein said seed tube has an upper end that fits around said seed chute and said upper end of said seed tube is moveable with respect to said seed chute, the improvement comprising
a spacer between a surface of said seed chute and a surface of said seed tube to reduce lateral movement of one with respect to the other thereof.

2. The improvement in accordance with claim 1 where said spacer has a tapered edge to aid in the assembly of said seed tube to said seed chute.

3. A spacer for use in a seed planter of the type having a metering unit for retaining a circular rotatable seed disk, said seed disk having a center, a first surface, a second opposing surface, and a plurality of transverse spaced vacuum holes through said seed disk, wherein seeds are introduced into a first cavity in a housing defined by said first surface and a vacuum is drawn into a second cavity in said metering unit defined by said second surface, such that seeds are retained against said vacuum holes until they are dropped through a seed chute and into a seed tube, and wherein said seed tube has an upper end that fits around said seed chute and said upper end of said seed tube is moveable with respect to said seed chute, the spacer comprising
a spacer body,
said spacer body attachable to one of an outer surface of said seed chute and an inner surface of said seed tube wherein said spacer reduces lateral movement of one of said seed chute and said seed tube with respect to the other.

4. The spacer of claim 3 wherein said spacer body has a tapered edge to aid in the assembly of said seed tube to said seed chute.

5. For a seed planter of the type having a metering unit for retaining a circular rotatable seed disk, said seed disk having a center, a first surface, a second opposing surface, and a plurality of transverse spaced vacuum holes through said seed disk, wherein seeds are introduced into a first cavity in a housing defined by said first surface and a vacuum is drawn into a second cavity in said metering unit defined by said second surface, such that seeds are retained against said vacuum holes until they are dropped through a seed chute and into a seed tube, said seed chute having an open end with a rectangular cross-section with parallel long sides and parallel short sides with said parallel short sides and a first of said parallel long sides being a removable cover extending across each of said parallel short sides and wherein said seed tube has an upper end that fits around said open end of said seed chute and wherein said upper end of said seed tube is moveable with respect to said seed chute,
a replacement cover having a body with a thickness that reduces said lateral movement between said seed chute and said upper end of said seed tube.
